(19) United States
(12) Patent Application Publication
(10) Pub. No.: US 2013/0179119 A1
(43) Pub. Date: Jul. 11, 2013

(54) DATA COLLECTION AND POINT CLOUD GENERATION SYSTEM AND METHOD

(71) Applicant: Robotics Paradigm Systems, LLC, Huntsville, AL (US)

(72) Inventors: Timothy Coddington, Huntsville, AL (US); Lynn Coddington Gilbert, Marietta, GA (US)

(73) Assignee: Robotics Paradigm Systems, LLC, Huntsville, AL (US)

(21) Appl. No.: 13/723,698

(22) Filed: Dec. 21, 2012

Related U.S. Application Data
(60) Provisional application No. 61/578,375, filed on Dec. 21, 2011.

(51) Int. Cl. G01C 3/08

(52) U.S. Cl. CPC G01C 3/08
USPC 702/159

(57) ABSTRACT

A system has a range-finding laser device coupled to an operator that performs a latest scan measuring a plurality of data points indicative of range and angle, an attitude inertial measurement unit (IMU) that is affixed to the range-finding laser device that measures pitch, roll, and yaw of the range-finding laser device, and two zero-velocity update (zupt) IMUs coupled to the operator that estimate position, velocity, and yaw of the operator. Further, the system has logic that transforms a plurality of data points from a sensor frame of reference, based upon measurements made, to a global frame of reference using data indicative of a latest global pose to obtain data indicative of transformed data points and merges the data indicative of the transformed data points with a point cloud.

### CROSS REFERENCE TO RELATED APPLICATIONS

This application claims priority to U.S. Provisional Application Ser. No. 61/578,375 entitled “Mobile Hand-held Device and Post Process for Rapid 2D and 3D Spatial, Video, and Audio Data Collection and Transformation into Visually and Dimensionally Accurate Geometric Features,” filed, which is incorporated herein by reference in its entirety.

### BACKGROUND

Light detection and ranging (LIDAR) used in laser devices is oftentimes used to measure distances of objects from the laser device. In this regard, the laser device emits a pulse, and a receiver positioned near the laser device receives a reflection from the object of the pulse emitted. The travel time from the time when the pulse was emitted to the time when the reflection is received by the receiver is used to calculate the distance, i.e., the distance is equal the product of the speed of light and the time of travel divided by two (2).

Additionally, an inertial measurement unit (IMU) may be used to measure the linear acceleration and angular velocity of an object, which is indicative of object's velocity and relative position, using various components, which may include accelerometers, gyroscopes, and/or magnetometers. The IMU detects a rate of acceleration of the object using the accelerometers and changes in attitude (relative to rotation of the object), including pitch, roll, and yaw using the gyroscopes.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a data collection and point cloud generation system in accordance with an embodiment of the present disclosure.

FIG. 2A is a drawing depicting an operator wearing an exemplary mobile unit such as is depicted in FIG. 1 in accordance with an embodiment of the present disclosure.

FIG. 2B is a drawing depicting a perspective left side view of an exemplary range-finding laser device such as is depicted in FIG. 2A

FIG. 2C is a drawing depicting a perspective right side view of the exemplary range-finding laser device such as is depicted in FIG. 2B.

FIG. 3 is a drawing depicting a back view of the mobile unit such as is depicted in FIG. 2A.

FIG. 4 is a drawing depicting an operator wearing another exemplary mobile unit in accordance with another embodiment of the present disclosure.

FIG. 5A is a drawing depicting an operator wearing another exemplary mobile unit in accordance with another embodiment of the present disclosure having a pitching range-finding laser device.

FIG. 5B is a side view of the range-finding laser device such as is depicted in FIG. 5A pitching upward 45°.

FIG. 5C is a side view of the range-finding laser device such as is depicted in FIG. 5A pitching upward 90°.

FIG. 5D is a side view of the range-finding laser device such as is depicted in FIG. 5A pitching downward 45°.

FIG. 5E is a back view of the range-finding laser device such as is depicted in FIG. 5A.

FIG. 6 is a block diagram of an exemplary mobile computing device such as is depicted in FIG. 1.

FIG. 7 depicts a perspective cross-sectional view of a room in which the mobile unit such as is depicted in FIG. 1 is positioned in order to gather data regarding structures (i.e., walls) within the room.

FIG. 8A is a top plan view of the room such as is depicted in FIG. 7.

FIG. 8B is a depiction of rendered scan data of a section of the room such as is depicted in FIG. 7.

FIG. 8C is a depiction of rendered scan data of another section of the room such as is depicted in FIG. 7.

FIG. 9 is a flowchart exhibiting exemplary functionality and architecture of control logic such as is depicted in FIG. 6.

FIG. 10 is a flowchart exhibiting another embodiment of exemplary functionality of process D such as is depicted in FIG. 9.

### DETAILED DESCRIPTION

The present disclosure generally pertains to a data collection and point cloud generation system. In particular, the data collection and point cloud generation system collects data indicative of a layout of a building, processes the data, and creates an image of the layout of the building. In one embodiment, a laser device is used to collect data indicative of the distance of walls from the laser device. In addition, one or more inertial measurement units (IMUs) is used to collect velocity and rotation data indicative of movement of the range-finding laser device during the period of time that the distance data is being collected. Based upon the distance data and the velocity and rotation data, the data collection and point cloud generation system can store and render an image of the layout of the building to a display device. Further, the display device may be a touch screen, and the data collection and point cloud generation system may be operated and/or controlled via the touch screen by an operator.

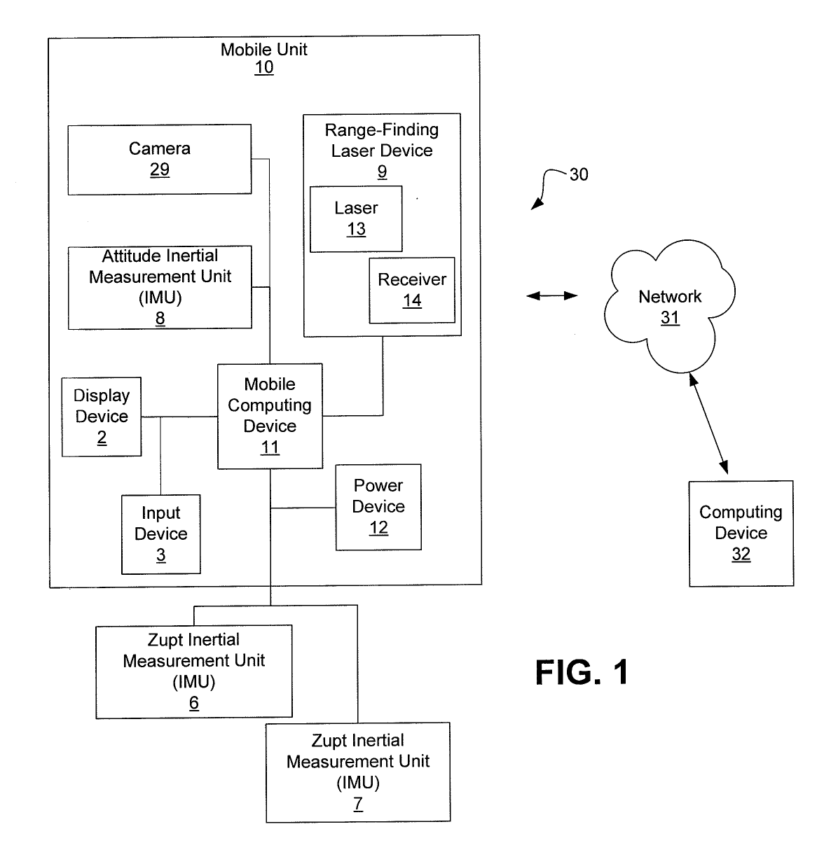

FIG. 1 is a block diagram illustrating a data collection and point cloud generation system 30 in accordance with an exemplary embodiment of the present disclosure. The system 30 comprises a computing device 32 and a mobile unit 10. The computing device 32 communicates with the mobile unit 10 via a network 31 or any other type of device or method for transferring data from the mobile unit 10 to the computing device 32. In one embodiment, for example, a memory stick (not shown) may be used to manually transfer data collected by the mobile unit 10 to the computing device 32.

The network 31 may be any type of network that enables the computing device 32 to communicate with the mobile unit 10. In this regard, the network 31 may be any type of network known in the art or future-developed. As an example, the network 31 may be a wireless local area network (WLAN or WiFi), and the computing device 32 may communicate with the mobile unit 10 via wireless transceivers (not shown).

The mobile unit 10 comprises a range-finding laser device 9, three inertial measurement units (IMUs) 6-8, a mobile computing device 11, an output device 2, a camera 29, input device 3, and a power device 12. The three IMUs 6-8 include an attitude IMU 8 and two zero velocity update (zupt) IMUs 6 and 7.

Note that the listed components are exemplary components. Additional or fewer components may be used in other embodiments to effectuate functionality of the system 30, to add functionality to the system 30, or to limit functionality of the system 30.

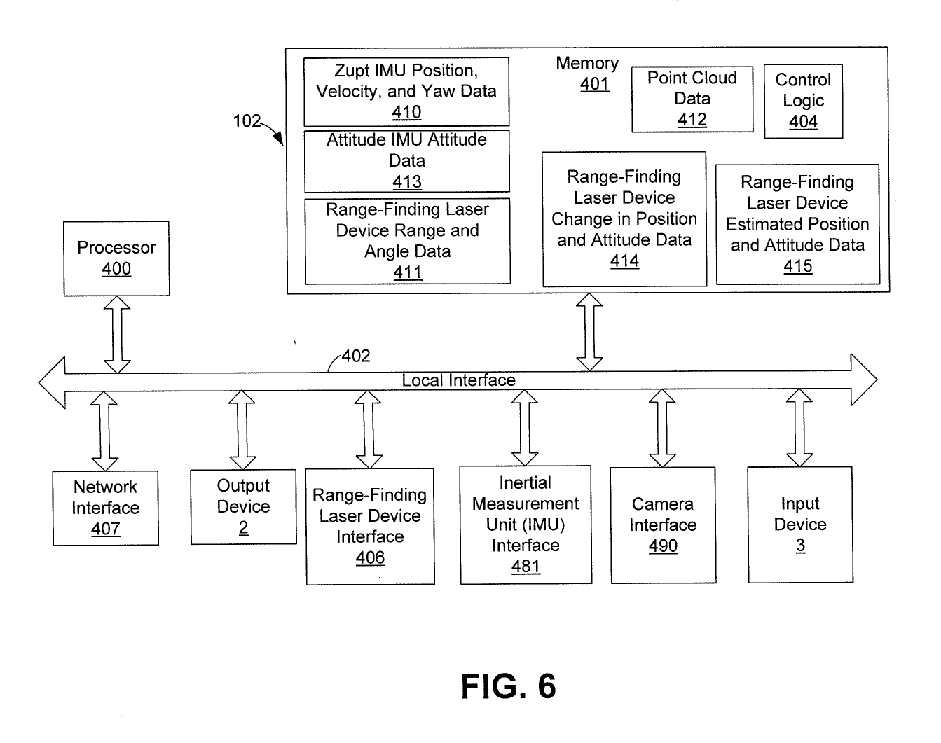

The mobile computing device 11 may be any type of computing device known in the art or future-developed. The mobile computing device 11 is described further herein with reference to FIG. 6.

The output device 2 is any type of output device known in the art or future-developed that outputs information. In one embodiment, the output device 2 is a display device that displays data to an operator (not shown) of the mobile unit 10, and such data may include images, for example. The images displayed to the output device 2 may be a rendering of a point cloud based upon data collected during operation via the range-finding laser device 9 and the IMUs 6-8. In this regard, the display device 2 may be a light emitting diode (LED) display device or the like. Other output devices may be used in other embodiments. For example, the output device 2 may be a headset.

In one embodiment, the range-finding laser device 9 employs LIDAR (light detection and ranging) in order to measure distances to an object, e.g., a wall or a military target. In one embodiment, a receiver 14 is coupled to the mobile unit 10, and in particular, the receiver 14 may be coupled to the range-finding laser device 9. The mobile unit 10 may use range-finding laser to determine a distance of an object, e.g., a wall, from the mobile unit 10.

In one embodiment, the range-finding laser device 9 collects range data indicative of distances of structures from the receiver 14. In one embodiment, the range-finding laser device 9 performs a scan and collects data (hereinafter referred to as scan data) indicative of a plurality of pulses received after reflection from the structure. As an example, the laser may rotate about a center axis and transmit and receive 1081 pulses during a scan, which can sweep 270°. In this regard, the first pulse in the scan is at index 1, and between the first pulse and the final pulse reflection receipt at index 1081, the laser has rotated 270° and collected data (hereinafter referred to as a scan) indicative of the distance of objects within the field of view of the range-finding laser device 9.

The power device 12 is any type of device presently known or future-developed for supplying power to the mobile computing device 11, the range-finding laser device 9, the attitude IMU 8, the zupt IMUs 6 and 7, the camera 29, and the display device 2. The power device 12 may be, for example, a battery.

The input device 3 is any type of input device that allows an operator to provide input to the mobile computing device 11. In one embodiment, the input device 3 is a keyboard. However, other input devices are possible in other embodiments. For example, the input device 3 may be a microphone and headphones for inputting voice commands and listening to prompts to the operator.

In one embodiment, the data collection and point cloud generation system 30 collects data indicative of locations of walls (i.e., data defining rooms) within a building. In this regard, an operator dons the mobile unit 10, and travels in and out of the rooms in the building. As the operator travels in and out of the rooms, the range-finding device 9 collects data indicative of locations of the walls from the range-finding laser device 9 over a period of time. The range-finding laser device 9 collects range data and angle data. In this regard, as described hereinabove, the range-finding laser device 9 performs a scan having a field of regard defined by the specific range-finding laser device employed. For example, the range-finding laser device 9 may have an opening allowing a scan of 270°. In addition, the range-fining laser device 9 may be configured to emit a pulse and receive a reflection of the pulse every ¼° (note that this is an approximation for exemplary purposes). Thus, a single scan by the range-finding laser device 9 comprises 1081 data points indicating time elapsed from emission to receipt of a pulse and the index of each data point in the scan indicates a relative angular displacement, which may be measured from a central axis of the laser.

The attitude IMU 8 is fixed relative to the range-finding laser device 9. In this regard, the attitude IMU 8 may be coupled to the housing of the range-finding laser device 9. The attitude IMU 8 collects inertial data indicative of yaw, pitch, and roll relative to the range-finding laser device's frame of reference.

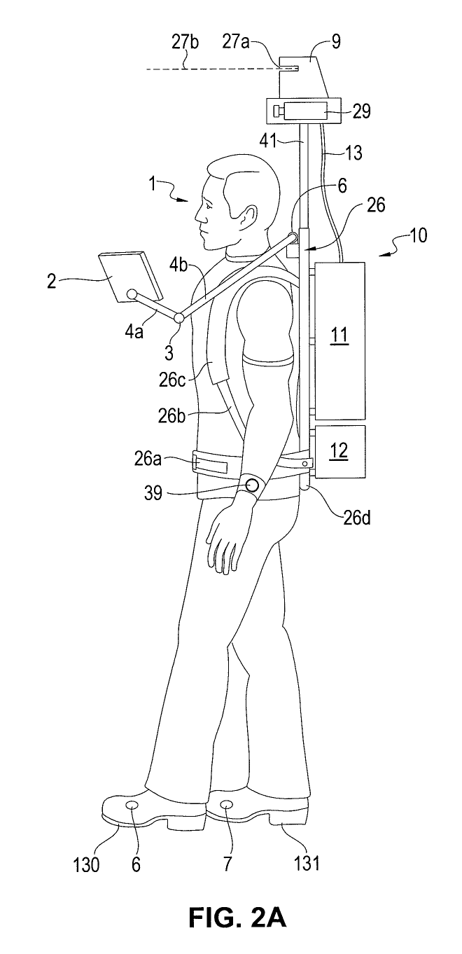

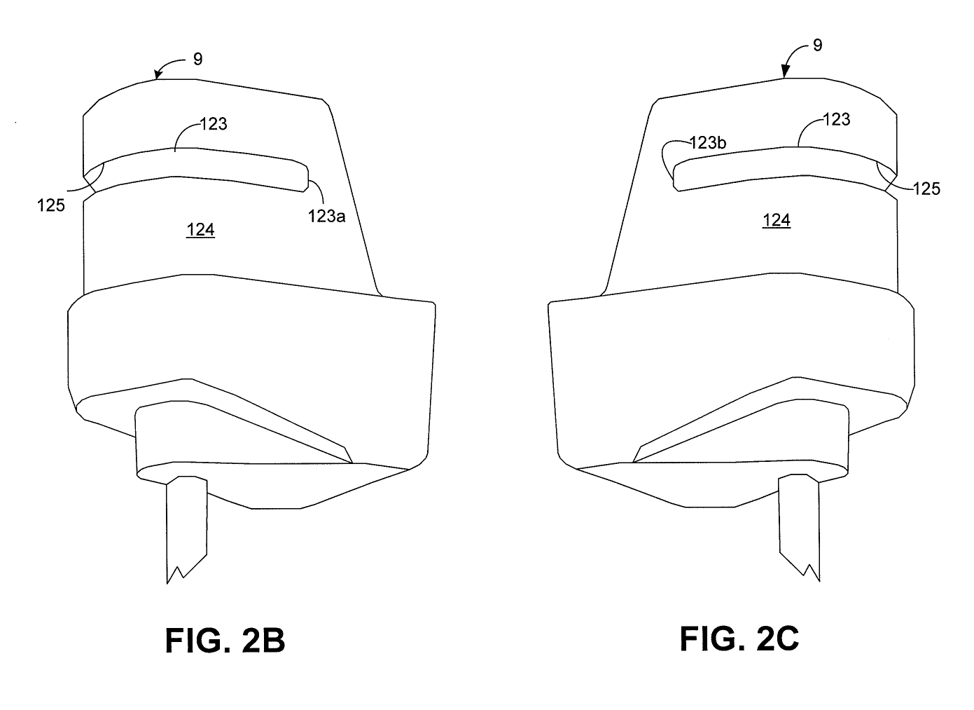

The zupt IMUs 6 and 7 collect angular rate and linear acceleration data. In one embodiment, the zupt IMUs 6 and 7 (as described with reference to FIGS. 2A, 3-5A) are coupled to an operator's feet. In such an embodiment, the zupt IMUs 6 and 7 calculate feet position and velocity. In addition, the zupt IMUs 6 and 7 collect data indicative of yaw relative to the operator's feet.

The attitude measured by the attitude IMU 8, the data indicative of the position, velocity, and yaw calculated by the zupt IMUs 6 and 7, and the range and angle measurements collected by the range-finding laser device 9 are transmitted to the mobile computing device 11. The mobile computing device 11 determines the estimated position and attitude of the range-finding laser device 9 based upon the data received from the attitude IMU 8, the zupt IMUs 6 and 7, and the range-finding laser device 9. Once the estimated position and attitude are determined, the mobile computing device 11 generates a point cloud using the estimated position and attitude.

In one embodiment, the mobile computing device 11 may render in real time an image representing one particular scan and/or combined scan(s) during operation. The image may show, for example, an outline of a wall, which is part of a layout for which the operator is collecting data with the system 30.

Additionally, the point cloud may be transmitted to the computing device 32 via the network 31 (or via another transfer method such as a memory stick). The computing device 32 may comprise additional imaging tools that allow a user to study, manipulate, and/or modify images generated from the point cloud.

During operation, the data collection and point cloud generation system 30 may further collect video via the camera 29. The video may be time synchronized with the other components of the system 30, i.e., the range-finding laser device 9 and the IMUs 6-8, such that subsequently the video may be used in conjunction with the collected data to provide additional information about particular characteristics of structures detected during operation.

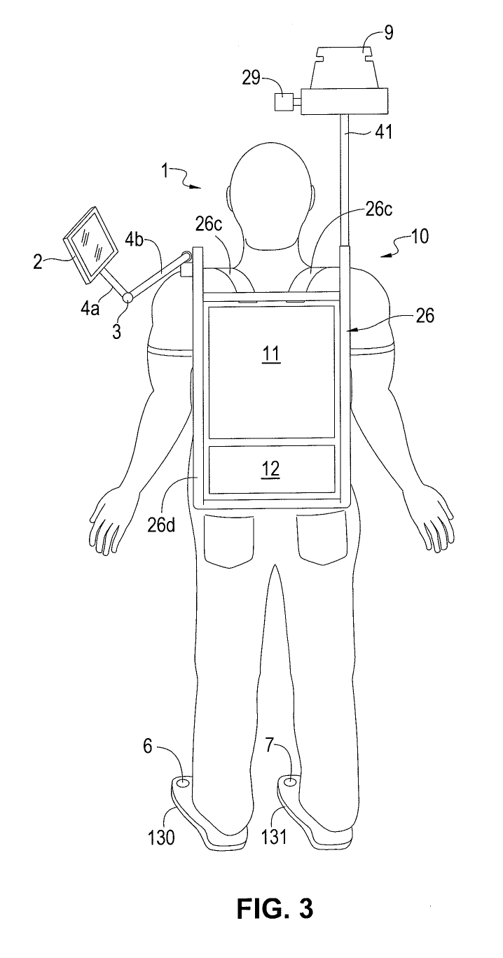

FIG. 2A-2C and 3 illustrate an exemplary mobile unit 10. In this regard, FIG. 2A depicts an operator 1 wearing the mobile unit 10 in accordance with an embodiment of the present disclosure. In such an embodiment, the mobile unit 10 is removably affixed to the operator 1 via one or more straps 26a through 26c of a backpack apparatus 26. The backpack apparatus 26 also comprises a frame 26d on which components (e.g., the mobile computing device 11 or the power device 12) can be mounted. The backpack apparatus 26 is merely an exemplary structure with which the mobile unit 10 may be removably affixed to the operator 1. Other structures may be used in other embodiments to removably affix the mobile unit 10 to the operator 1.

The mobile unit 10 comprises the range-finding laser device 9 communicatively coupled to the mobile computing device 11 via a cable 13. Note that the attitude IMU 8 (FIG. 1) is fixed relative to a center point 27a of the range-finding laser device 9 and is also in communication with the mobile computing device 11 via a cable 13. Further note that FIG. 2A depicts a line 27b that represents a center axis extending from the center point 27a, which is described further herein. While cables are described in implementation of one embodiment of the present disclosure, other structures and/or methods may be used to communicate data from the range-finding laser device 9 and the attitude IMU 8 to the mobile computing device 11. As an example, data may be communicated wirelessly.

As described herein, the mobile unit 10 further comprises the output device 2. Any type of output device presently known or future-developed may be used in the mobile unit 10. In one embodiment, the system 30 may comprise a wrist display device 39. The wrist display device 39 is communicatively coupled to the mobile computing device 11 such that images may be rendered to the wrist display device 39 representative of data collected during operation.

In one embodiment, the output device 2 is a display device and the display device is adjustably affixed to the backpack apparatus 26 via an arm. The arm comprises a front member 4a that is attached to a back member 4b via a joint 3. In one embodiment, the joint 3 is implemented with degrees of freedom that allow the display device to be adjusted up/down, backward/forward, left/right, and/or rotated (or tilted) for ease of viewing by the operator 1. The first member 4a is coupled to the display device 2, and the second member 4b is coupled to the backpack frame 26d via a joint 6. The joint 6 is also implemented with degrees of freedom that allow the display device to be adjusted.

Further, the zupt IMUs 6 and 7 are fixedly coupled to the operator's shoes 130 and 131, which are coupled to the operator's feet (not shown). The zupt IMUs 6 and 7 collect linear acceleration and angular rates related to movement of the operator's feet and transmit data indicative of the feet's position, velocity, and yaw to the mobile computing device 11. Such data is communicated, either wirelessly or otherwise, to the mobile computing device 11.

FIG. 2B depicts perspective view of a left side of the range-finding laser device 9. In one embodiment, the range-finding laser device 9 comprises a laser (not shown) contained within the housing 124. Further, an aperture 123 in the housing is defined by an edge 125 of the housing. The laser contained in the housing 124 is situated such that its field of view aligns vertically with the aperture 123, and light emitted from the laser propagates through the aperture 123 out of the housing 124.

During operation, the laser rotates 360° such that light propagates out of the housing through the aperture 123. In one embodiment, the aperture 123 has an arc length that allows data to be collected for a 270° scan of a field of regard. During a single scan, light from the laser begins to propagate from the aperture at edge 123a. As the laser continues to rotate, light propagates through aperture 123 until it rotates to edge 123b (shown in a perspective view of a right side of the range-finding laser device 9 in FIG. 2C) of the aperture 123. Thus, the range-finding laser device 9 can perform a 270° scan as it rotates.

FIG. 3 depicts a back view of the mobile unit 10. As shown, the operator 1 wears the mobile unit 10, which is attached to the operator 1 via the backpack frame 26d. The range-finding laser device 9 is coupled to an extending pole 41, which elevates the range-finding laser device 9 vertically with respect to the remaining components in the mobile unit 10.

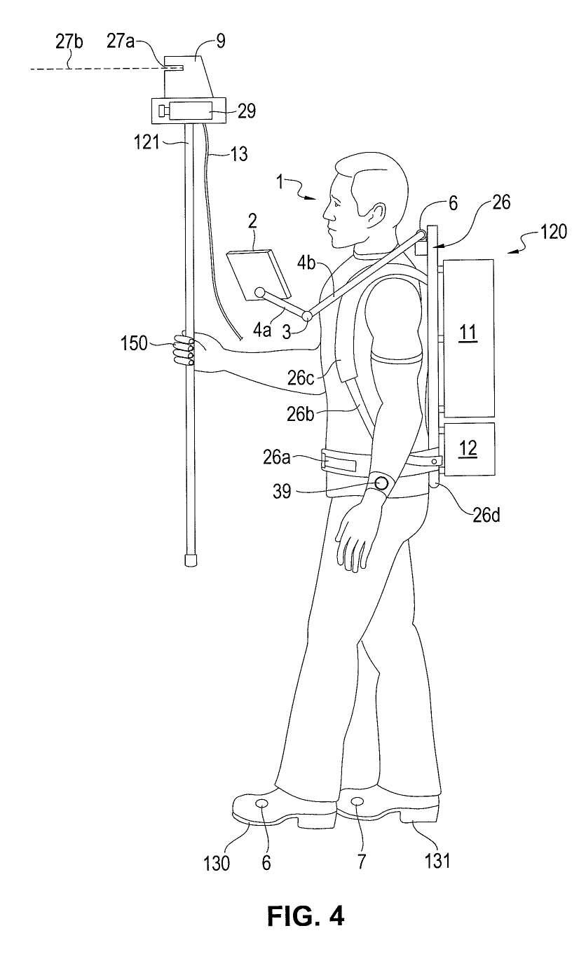

FIG. 4 illustrates another exemplary mobile unit 120 in accordance with another embodiment of the present disclosure wherein the range-finding laser device 9 is not coupled to the backpack frame 26d. In such an embodiment, the mobile unit 120 comprises an extendable (i.e. telescoping) pole 121 that the operator 1 grasps with his/her hand 150. The operator continues to grasp the pole 121 and maintains the range-finding laser device 9 in an elevated position as he/she traverses a building for which the operator is collecting data in order to generate a layout.

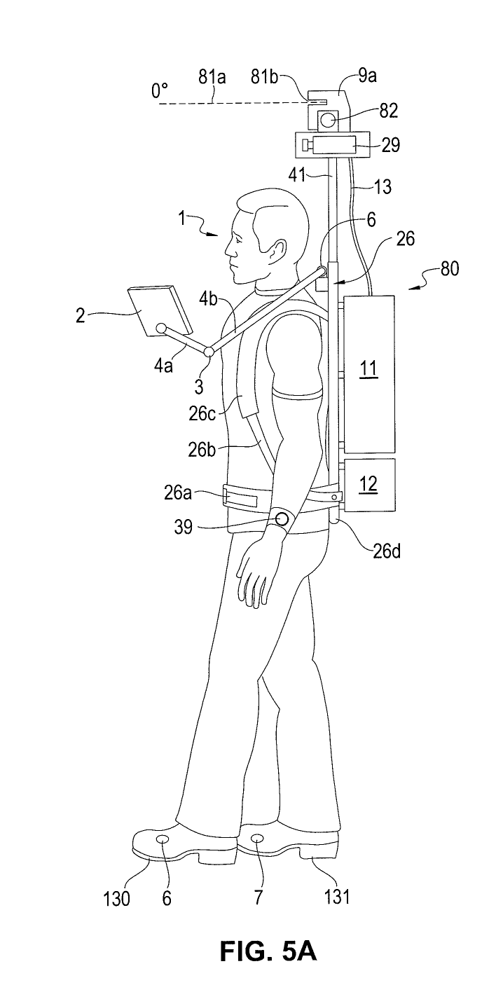

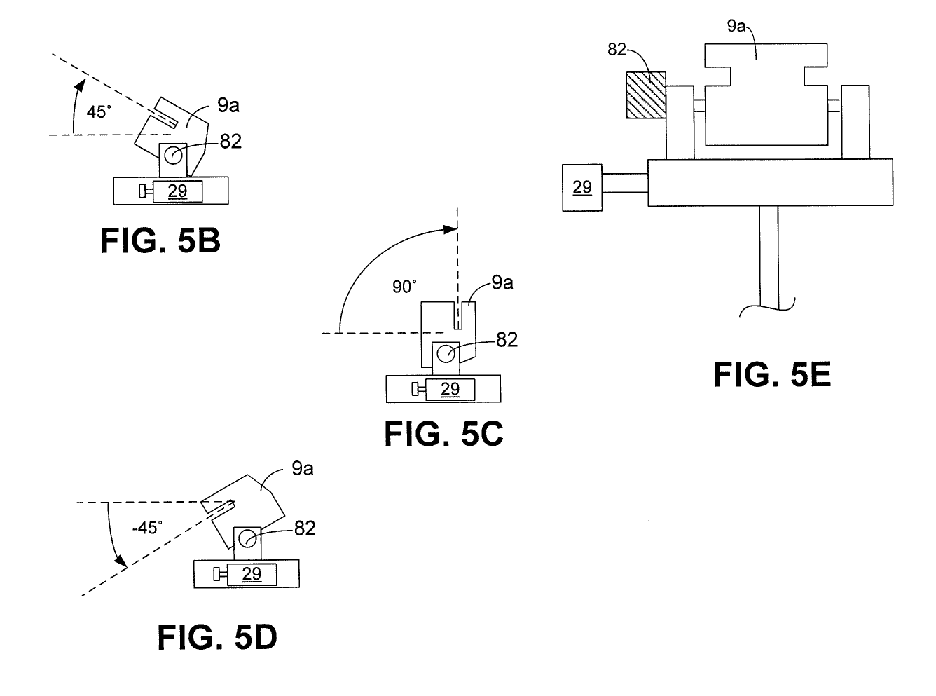

FIGS. 5A-5E illustrate another exemplary mobile unit 80 in accordance with an embodiment of the present disclosure. The mobile unit 80 is substantially similar to the mobile unit 10 depicted in FIG. 2A except for the range-finding laser device 9a.

In this regard, the mobile unit 80 comprises the range-finding laser device 9a communicatively coupled to the mobile computing device 11 via the cable 13. Further note that FIG. 5A depicts a line 81a that represents a center axis extending from the center point 81b identified at 0°, which is described further herein. The range-finding laser device 9a further comprises a motor 82, which when actuated, rotates the range-finding laser device 9a changing the pitch at which the range-finding laser device 9a operates. When the range-finding laser device 9a operates at 0°, the data collected is similar to that collected as described herein with reference to FIG. 2A.

FIG. 5B depicts a side view of the range-finding laser device 9a when the range-finding laser device 9a is rotated upward 45°. Further, FIG. 5C depicts a side view of the range-finding laser device 9a when the range-finding laser device 9a is rotated upward 90°, and FIG. 5D depicts a side view of the range-finding laser device 9a when the range-finding laser device 9a is rotated downward 45°. Note that the range-finding laser device 9a is pitched in this embodiment by the motor 82. However, such pitching may also be effectuated manually by the operator rotating the range-finding laser device 9 (in FIG. 4) while the operator is moving about a room or room-to-room in a building.

As the range-finding laser device 9a is pitched upward and downward as described, data indicative of ranges and angles may be measured and collected for structures lying within the field of view of the range-finding laser device 9a, e.g., data points located on an entire wall from ceiling to floor and/or data points on the ceiling and/or data points on the floor. Thus, in effect, data representative of a three-dimensional structure (and hence three-dimensional data) may be obtained via the mobile unit 80.

FIG. 6 is a block diagram of an exemplary mobile computing device 11 in accordance with an embodiment of the present disclosure. The mobile computing device 11 comprises a processing unit 400, a network interface 407, a range-finding laser device interface 406, an IMU interface 481, a display device 2, an input device 3, a camera interface 490, and memory 401. Each of these components communicates over a local interface 402, which can include one or more buses.

In addition, the mobile computing device 11 comprises control logic 404. The control logic 404 can be implemented in software, hardware, firmware or any combination thereof. In the exemplary mobile computing device 11 shown in FIG. 6, control logic 404 is implemented in software and stored in memory 401. Memory 401 may be of any type of memory known in the art, including, but not limited to random access memory (RAM), read-only memory (ROM), flash memory, and the like.

Processing unit 400 may be a digital processor or other type of circuitry configured to run the control logic 404 by processing and executing the instructions of the control logic 404. The processing unit 400 communicates to and drives the other elements within the mobile computing device 11 via the local interface 402, which can include one or more buses.

In addition, the network interface 407 may support any type of communication device (e.g., a modem) that communicatively couples the mobile computing device 11 with the network 31 (FIG. 1). Further, the range-finding laser device interface 406 and the IMU interface 481 are any type of interfaces that communicatively couple the mobile computing device 11 with the range-finding laser device 9 (FIG. 1) or 9a (FIG. 5A) and the IMUs 6-8 (FIG. 1), respectively. In this regard, the interfaces 406 and 481 receive data from the range-finding laser device 9 or 9a and the IMUs 6-8 and translate the received data for processing by the control logic 404.

The camera interface 490 is any type of interface known in the art or future-developed for communicating with the camera 29 (FIG. 1). The camera interface 490 may be software, hardware, or any combination thereof for communicatively connecting to the camera 29.

The input device 3 is any type of input device known in the art or future-developed for receiving input from the operator 1 (FIG. 2A). As mere examples, the input device 3 may comprise a microphone (not shown), a keyboard (not shown), or any other type of human interface device that enables the operator to provide input to the mobile computing device 11.

During operation, the control logic 404 receives from the IMUs 6-8, via the IMU interface 481, zupt IMU position, velocity, and yaw data 410 (zupt IMUs 6 and 7) and attitude IMU attitude data 413 (attitude IMU 8). Upon receipt, the control logic 404 stores the data 410 and 413 in memory 401.

Further, the control logic 404 receives from the range-finding laser device 9 range and angle data 411 and stores the range and angle data 411 in memory 401. Upon receipt, the control logic 404 convert the latest range and angle data to Cartesian data. Further, the control logic 404 compares the latest Cartesian data with the last Cartesian data and derives a change in position and attitude based upon the comparison, which the control logic 404 stores as change in position and attitude data 414 in memory 401.

The control logic 404 processes the data 410, 414, and 413 to generate data indicative of an estimated position and attitude 415 of the range-finding laser device 9. The estimated position and attitude data 415 of the range-finding laser device 9 is then used to transform scan data, derived from range-finding device range data 411, to a three-dimensional frame of reference so it can be added to the point cloud data 412. Note that the point cloud data 412 is a collection of laser scan data over time and at any given moment, when displayed, is indicative of a layout of a structure that has been walked through.

Further, the control logic 404 may display an image indicative of the point cloud data 412 to the display device 2. In one embodiment, the control logic 404 stores the point cloud data 412, which may at a subsequent time be transferred to the computing device 32 (FIG. 1) via the network interface 407 or by some other means, e.g., by transferring the point cloud data 412 to a removable memory device to which the point cloud data 412 is transferred, e.g., copied.

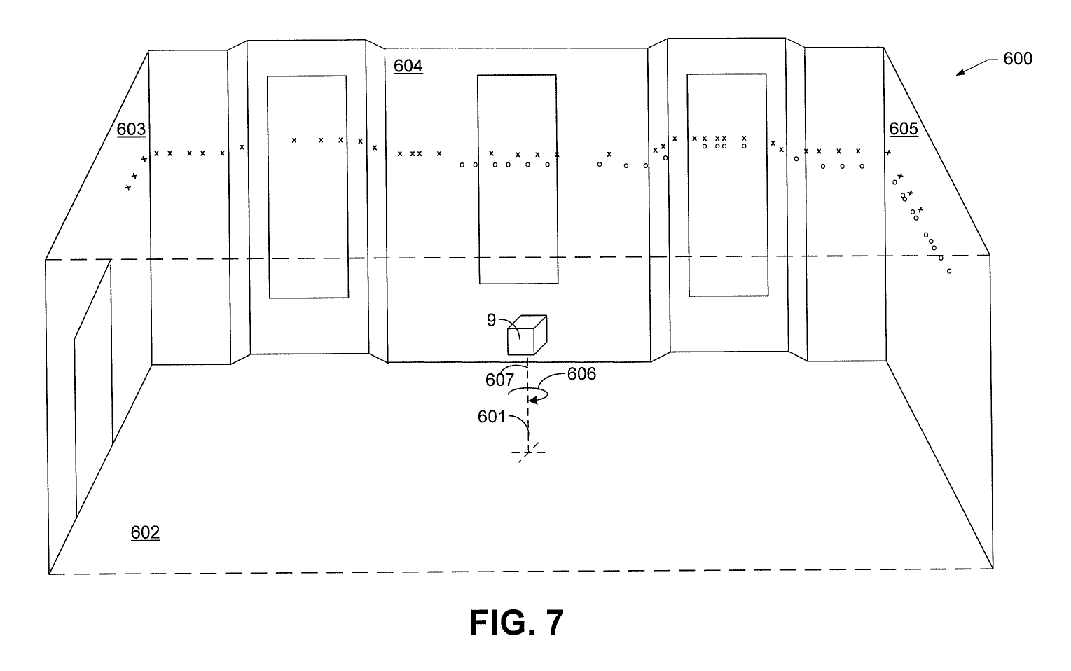

FIG. 7 depicts a perspective cross-sectional view of a room 600. Further, FIG. 7 depicts a range-finding laser device 9, which is symbolized by a cube for simplicity. The position symbol 601 indicates that the range-finding laser device 9 is elevated from the floor 602 to simulate a position of the range-finding laser device 9 when it is coupled to a backpack frame 26d (FIG. 2A) or coupled to a pole 121 and carried in an elevated position as depicted in FIG. 4 relative to the various walls 603-605 and the floor 602.

For purposes of discussion in explaining the data collection and point cloud generation system 30 (FIG. 1), assume that the range-finding laser device 9 comprises the aperture 123 (FIG. 2B), and that the aperture 123, as described hereinabove, provides a particular field of view. Furthermore, the reference arrow 606 is shown to illustrate a 360° clockwise rotation about a central axis 607 of the laser (not shown) contained within the range-finding laser device 9. Thus, as the laser rotates within the housing 124 (FIG. 2B), light emitted from the laser begins propagating outward toward the wall 603 (assuming that the side of the range-finding laser device 9 is facing the wall 604) at edge 123a (FIG. 2B) of the aperture 123. The laser rotates and the last reading is taken at edge 123b (FIG. 2C) of the aperture 123.

As described hereinabove, the range-finding laser device 9 collects range data. The range data collected is a plurality of data points, each data point of the distance from the range-finding laser device 9 to the wall struck by the pulse emitted as it scans the span of 270°. For purposes of explanation, a set of data points corresponding to a single scan of the laser is hereinafter referred to as scan data. In the example provided, wherein the aperture 123 allows a 270° scan, the range-finding laser device 9 determines time differentials (at) for each pulse emitted/received and calculates the distance traveled by the pulse, which indicates range (or distance) to the wall detected. In addition, the index of a particular data point in the scan data also provides angular information indicative of the angular offset of the laser beam (which may be relative to a central axis 27b (FIG. 2A) as it rotates. As an example, the range-finding laser device 9 may collect a data point (i.e., a range data point) every ¼° in a 270° field of view, which means that approximately 1081 data points are collected for a scan. So as an example, the following represents scan data for a single scan (i.e., 270°):

| | Angle | |
|---|---|---|
| | Differential | |
| | From | |
| | Central | |
| Index | Axis | Measured Range |
| 1 | ∠ = −135° | Range₁ |
| 2 | ∠ = −134.75° | Range₂ |
| . | . | . |
| . | . | . |
| . | . | . |
| 1080 | ∠ = 269.75° | Range₁₀₈₀ |
| 1081 | ∠ = 270° | Range₁₀₈₁ |

Thus, for each set of scan data, there is range data indicating the range measured by the range-finding laser device 9 and there is angular data indicating an angle difference between the central axis 27b and the position of the laser when the corresponding measurement was taken.

FIG. 7 comprises indicators including a set of “x” indicators and a set of “o” indicators, illustrating two sets of scan data. In this regard, the “x” indicators depict what will be referred to hereinafter as Scan_{A}, and the “o” indicators depict what will be referred to hereinafter as Scan_{B}. Note that the “x” indicators and the “o” indicators represent points on the walls 603-605 for which scan data is collected during a scan of the laser. During operation, an operator 1 (FIG. 2A) traverses the room 600 either wearing the mobile unit 10 having the range-finding laser device 9 (FIG. 2A) or range-finding laser device 9a (FIG. 5A) or carrying the range-finding laser device 9 (FIG. 4). The range-finding laser device 9 or 9a collects scan data indicative of the distance to each point located on the walls 603-605.

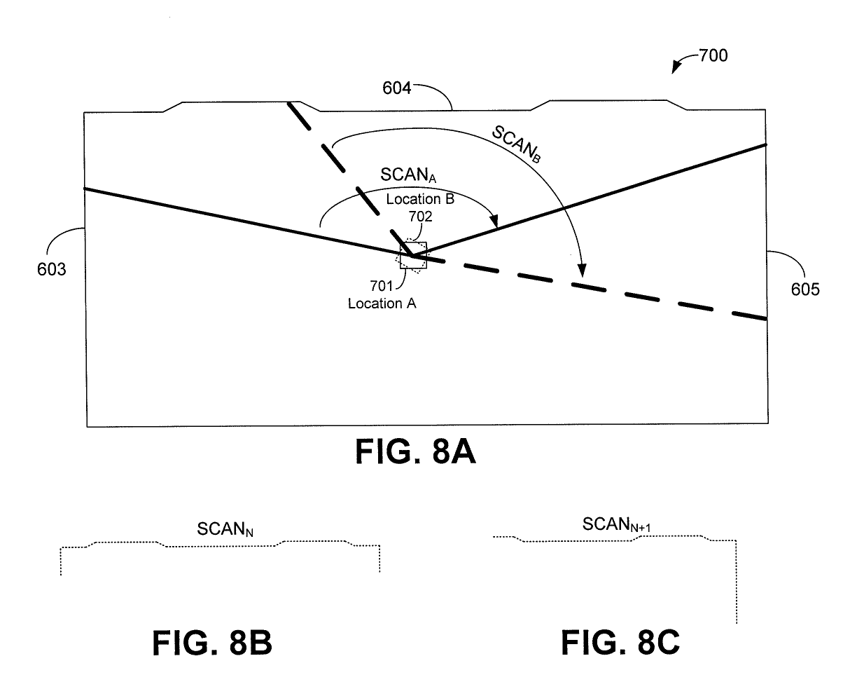

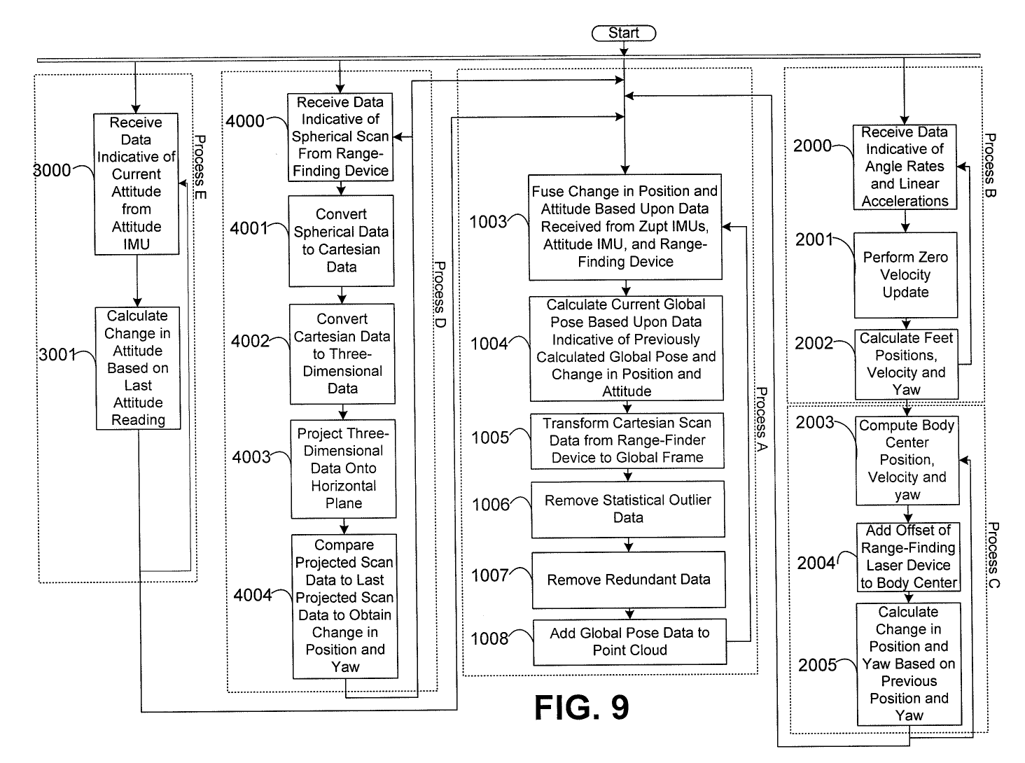

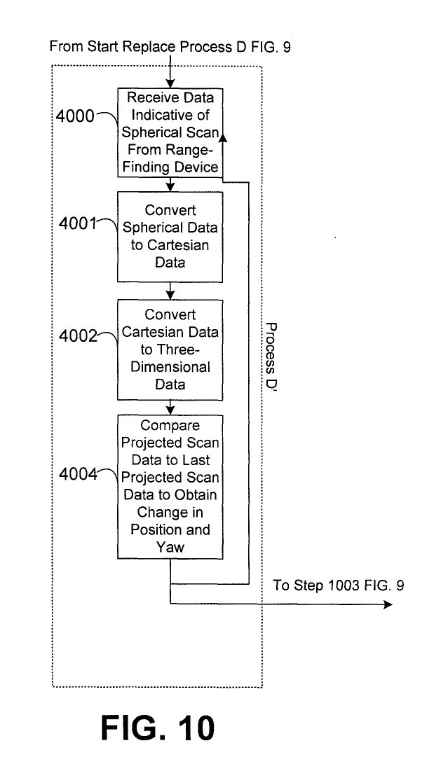

FIGS. 8A-8C further illustrate operation of the data collection and point cloud generation system 30 during collection of range and angle data 411 (FIG. 6) and processing of change in position and attitude data 414, attitude data 413, and position, velocity, and yaw data 410 in order to generate the point cloud data 412. In this regard, the square symbol 701 represents the range-finding laser device 9 and depicts a position (hereinafter referred to as “location A”) of the range-finding laser device 9 during a scan having a field of regard identified in FIG. 8A as Scan_{A}. The Scan_{A} field of regard corresponds to the set of data points identified in FIG. 7 with the “x” identifiers.

Note that a laser sweep having the field of regard of Scan_{A} produces a data set hereinafter identified as Scan_{N} that comprises range and angle data for a single scan taken at time t₁ having values associated with a plurality of data points corresponding to the “x” identifiers (FIG. 7). Further, FIG. 8B depicts an outline showing a exemplary graph of the data points contained in Scan_{N} after processing by the mobile computing device 11.

In location A, the range-finding laser device 9 has an attitude (hereinafter referred to as Attitude_{A}), which is measured by the attitude IMU 8 (FIG. 1). Thus, the mobile computing device 11 receives data indicative of Attitude_{A} from the attitude IMU 8. As described hereinabove, the attitude IMU 8 is fixedly coupled to the range-finding laser device 9 (FIG. 1). Note that Attitude_{N} comprises data indicative of roll, pitch, and yaw at the time (t₁) when the measurement is taken by the attitude IMU 8.

Further, in location A, the zupt IMUs 6 and 7 (FIG. 1) measure angle rates and linear acceleration, which are used to calculate position, velocity and yaw of the operator's feet (FIG. 2A). In one embodiment, the zupt IMUs 6 and 7 are coupled to shoes 130 (FIG. 2A) and 131 (FIG. 2A) of the operator 1 (FIG. 2A), which bears on (but is not identical to) the position and velocity of the range-finding laser device 9. In one embodiment, calculation of position, velocity and yaw based on the measured angle rates and linear acceleration is performed by logic (not shown) resident on the zupt IMUs 6 and 7; however, such calculation could be performed by the mobile computing device 11 in other embodiments of the present disclosure. Note that the position, velocity and yaw of the operator's feet calculated by the zupt IMUs 6 and 7 is position, velocity and yaw at a particular instant in time (t₁).

The square symbol 702 represents the range-finding laser device 9 when it has been rotated such that it collects data for a different section of the walls 604 and 605, i.e., the field of regard has changed based upon rotation of the range-finding laser device 9. In this regard, the square symbol 702 represents the range-finding laser device 9 and depicts a location (hereinafter referred to as “location B”) of the range-finding laser device 9 during a scan having a field of regard identified in FIG. 8A as Scan_{B}. The Scan_{B} field of regard corresponds to the set of data points identified in FIG. 7 with the “o” identifiers.

Note that the scan having the field of regard of Scan_{B} produces a data set hereinafter identified as Scan_{N+1} that comprises range and angle data for a single scan taken at time t₂ having values associated with a plurality of data points corresponding to the “o” identifiers (FIG. 7). Further, FIG. 8C depicts an outline showing a exemplary graph of the data points contained in Scan_{N+1} after processing by the mobile computing device 11.

In location B, the range-finding laser device 9 has an attitude (hereinafter referred to as Attitude_{B}), which is measured by the attitude IMU 8 (FIG. 1). Thus, the mobile computing device 11 receives data indicative of Attitude_{B} from the attitude IMU 8 at a particular instant in time (t₂).

Further, in location B, the zupt IMUs 6 and 7 (FIG. 1) measure angle rates and linear acceleration, which are used to calculate position, velocity and yaw of the operator's feet (FIG. 2A). Note that the position, velocity and yaw of the operator's feet calculated by the zupt IMUs 6 and 7 is position, velocity and yaw at a particular instant in time (t₂).

Additionally, the control logic 404 calculates the operator's body center position and attitude based on the operator's feet position and attitude provided by zupt IMUs 6 and 7. Once the operator's body center position and attitude are determined, the control logic 404 adds a predetermined offset that has been measured between the operator's body center and the range-finding laser device's center point.

In calculating a global pose of the range-finding laser device 9, the mobile computing device 11 receives Attitude_{N} data from the attitude IMU 8, Scan_{N} from range-finding laser device 9, and position, velocity, and yaw from the zupt IMUs 6 and 7. Such data is indicative of measurements taken at time t₁. Additionally, the mobile computing device 11 receives Attitude_{N} data from the attitude IMU 8, Scan_{N} from range-finding laser device 9, and position, velocity, and yaw from the zupt IMUs 6 and 7. Such data is indicative of measurements taken at time t₂.

The control logic 404 calculates a change in attitude from t₁ to t₂. Such change is a calculated attitude difference as indicative of a difference between Attitude_{B} (at t₂) and Attitude_{A} (at t₁). The difference is hereinafter referred to as “Delta Attitude.” Further, the control logic 404 calculates a change in position from t₁ to t₂. Such change is derived from a difference indicative of a difference between Location B (at t₂) and Location A (at t₁). The difference is hereinafter referred to as “Delta Position”.

The control logic 404 performs a variety of operations on the range and angle data 411 in order to calculate the estimated change in position and attitude data 414 needed to determine the global pose of the range-finding laser device 9. Initially, the range and angle data 411 is measured in a spherical coordinate system from the range-finding laser device's frame of reference. The control logic 404 converts the range and angle data to Cartesian coordinates in an X-Y plane thereby generating, for each data point in Scan_{N} and Scan_{N+1}, (x, y, 0). In this regard, the data is in the range-finding laser device's frame of reference.

Using the latest computed pitch and roll from the attitude IMU 8, the control logic 404 converts the Cartesian coordinates (x, y, 0) of Scan_{N+1} to three-dimensional, noted as (x′, y′, z′). At this point in process, the three-dimensional coordinates (x′, y′, z′) are also in the frame of reference of the range-finding laser device 9. The control logic 404 then projects the three-dimensional coordinates onto a horizontal plane (not shown) by setting the z′-value of each data point to zero (0), noted as (x′, y′, 0). In the embodiment of mobile unit 80, the control logic 404 does not perform the projection onto a horizontal plane.

The control logic 404 then performs a scan matching method on Scan_{N} data (i.e. last scan) and Scan_{N+1} data (i.e. latest scan). In this regard, the control logic 404 compares data points contained in Scan_{N+1} with Scan_{N} to determine a change in position and attitude, which is indicative of Delta Position and Delta Attitude. Any type of scan matching method known in the art or future-developed may be used to compare Scan_{N+1} with Scan_{N} to determine change in position in accordance with an embodiment of the present disclosure.

The control logic 404 then uses a filter to determine an estimated change in position and change in attitude, indicative of a change in global pose, using a combination of change in position and change in attitude calculated from two sources, which include the scan matching method and zupt process. In one embodiment, the control logic 404 employs an Extended Kalman Filter (EKF). The inputs to the EKF include the results of the scan matching method (difference between Scan_{N+1} and Scan_{N}) and the results of the zupt process.

The control logic 404 determines a latest global pose, i.e., (x, y, z, roll, pitch, yaw) based on the change in global pose. In this regard, the control logic 404 calculates the latest global pose by adding the latest change in global pose to the last global pose.

The control logic 404 then transforms the Scan_{N+1} for time t₂ (i.e., Scan_{N} data points) from the sensor frame of reference to the global (or room) frame of reference. The transform is performed using the Cartesian coordinates converted from the range and angle data 411 received from the range-finding laser device 9.

During the course of scanning structures and obtaining data indicative of the structures, there may be spurious data points that fall outside the prevalent general location of other data points. In this regard, there may be quick movements of the operator or a malfunction in equipment (e.g., the IMUs or the laser) that causes such statistical outliers. In one embodiment of the system 30, the control logic 404 may perform a filtering method for removing such statistical outliers from the transformed Scan_{N+1} data before it is added to the point cloud data 412.

Further, during course of operation, the operator 1 may hold the range-finding laser device 9 still for a period of time and not physically move such that data obtained by the range-finding laser device 9 becomes redundant. Thus, before adding transformed Scan_{N+1} data to the point cloud data 412, the control logic 404 may determine when the range-finding laser device 9 was not moving, i.e., a period of non-movement of the operator, and eliminate redundant data during that period of non-movement thereby generating data hereinafter referred to as new transformed scan data.

The control logic 404 adds the new transformed scan data to the point cloud data 412. Thus, the point cloud data 412 after the addition reflects the latest data points indicative of the structures scanned by the range-finding laser device 9.

FIG. 9 is a flowchart depicting exemplary functionality of the control logic 404 (FIG. 6) in accordance with an embodiment of the present disclosure.

The flowchart depicts five processes, including process A, B, C, D, and E. The parent process that generates the point cloud data 412 (FIG. 6) is Process A. In this regard, Process A receives data from processes C-E, which is used in generation of the updated global pose, indicative of range-finding laser device estimated position and attitude, 415, and point cloud data 412. Each of the processes B-E execute simultaneously during operation of the data collection for each range-finding laser scan and then following execution of processes B-E, process A updates the global pose and adds new scan data to the point cloud data 412 for system 30.

Process B comprises three steps including 2000-2002. In one embodiment, steps 2000-2002 are performed by the zupt IMUs 6 and 7 (FIG. 1); however, steps 2000-2002 could be performed by the control logic 404 of the mobile computing device 11.

In step 2000, independent processors (not shown) of the zupt IMUs 6 and 7 receive data indicative of angle rates and linear accelerations of the foot to which the zupt IMU 6 and 7 are attached. Such angle rates and linear accelerations relate to motion characteristics of the operator's feet as he/she moves or traverses a room(s) in the building of interest.

Upon receipt of the angle rates and linear accelerations, each processor performs a zero velocity update (zupt) in step 2001. A zero velocity update is a method where zero velocity intervals are detected and any error contained in the measurements is reset or set to zero. In the particular system 30, zero velocity occurs when the operator's foot is at rest, which may be a very quick moment in time while the operator walks.

In step 2002, the processor calculates the position and velocity of the operator's foot based upon the measured angle rates and linear accelerations received. Note that in addition to position and velocity, the zupt IMUs 6 and 7 further provide data indicative of attitude.

Once process B derives position, velocity, and yaw of the operator's feet, process B begins again at step 2000. In this regard, process B is a continual process on each zupt IMU 6 and 7 that runs during operation of the system 30 such that data indicative of the position, velocity, and yaw of the operator's feet is continually updated based upon movement of the operator.

Process C comprises three steps including 2003-2005. Steps 2003-2005 are performed by the control logic 404.

In step 2003, control logic 404 computes data indicative of an estimated body center of the operator based upon the position, velocity, and yaw from each foot computed independently by the zupt IMU processors, 6 and 7, in step 2002.

As shown in regard to FIG. 2A, FIG. 4, and FIG. 5A, the range-finding laser device 9 and 9a may be located at a particular position offset from the operator's body center while the system 30 is collecting data. Thus, to account for such offset, in step 2004, the control logic 404 augments the position, velocity, and yaw of step 2003 to account for the offset between the operator's body center and the range-finding laser device 9 (FIG. 1) or 9a (FIG. 5A). In this regard, augmentation results in the zupt IMUs' derived position, velocity, and yaw of the range-finding laser device 9.

Once position, velocity, and yaw data are derived for the range-finding laser device 9 based on zupt IMU position, velocity, and yaw, the control logic 404 calculates a difference between the latest derived position and yaw and the last derived position and yaw to determine an estimated change in position and yaw.

Process C begins again at step 2003. In this regard, process C is a recurring process that runs during operation of the system 30 such that data indicative of the change in the range-finding laser device's position and yaw based upon the zupt IMUs 6 and 7 is continually updated based upon movement of the operator and synchronized to each range-finding laser scan cycle (t).

Process D comprises five steps including 4000-4004. Steps 4000-4004 are performed by the control logic 404.

In step 4000, control logic 404 receives spherical data indicative of range and angle from the range-finding laser device 9. In step 4001, the control logic 404 converts the range and angle spherical data to Cartesian data, i.e., each data point having a radial distance (the distance from the range-finding laser device 9 to the walls) and an angle is converted to x, y coordinates represented (x, y, 0) in Cartesian notation. Note that there is no z component considered in these coordinates because the range-finding laser device 9 collects data in the x-y (horizontal) plane only.

In step 4002, the control logic 404 converts the Cartesian data points (x, y, 0) for each data point in the scan to three-dimensional data based upon data indicative of the attitude (pitch and roll) provided by the attitude IMU 8 (FIG. 1), which is described further herein. This results in data hereinafter referred to as (x′, y′, z′), which is in the range-finding laser device's frame of reference.

In step 4003, the control logic 404 projects each three-dimensional data point onto a horizontal plane, i.e., the x-y horizontal field of regard of the range-finding laser device 9. The result is data hereinafter are referred to as (x′, y′, 0). In the embodiment of the mobile unit 80 (FIG. 5A), step 4003 is not used. Instead, the three-dimensional data (x′, y′, z′) is used.

In step 4004, the control logic 404 compares the latest scan data (i.e. Scan_{N+1} at t₂) to the last scan data (i.e. Scan_{N} at t₁) using a scan matching method to obtain the scan matching method derived change in position and attitude. Such data is hereinafter identified as (dX, dY, dZ) and (dYaw, dPitch, dRoll).

Process D begins again at step 4000. In this regard, process D is a recurring and iterative process that runs during operation of the system 30 such that data indicative of the change in position and yaw based upon consecutive scan from the range-finding laser device 9 is continually updated based upon movement of the range-finding laser device 9.

Process E comprises two steps including 3000-3001. Steps 3000-3001 are performed by the control logic 404.

In step 3000, control logic 404 receives attitude data indicative of roll, pitch, and yaw from the attitude IMU 8 (FIG. 1). This computed attitude data is also the attitude data used in step 4002 of process D to convert the Cartesian coordinates to three-dimensional data.

In step 3001, the control logic 404 calculates a change in attitude using a difference between the latest attitude and the last attitude.

Process E begins again at step 3000. In this regard, process E is a recurring and iterative process that runs during operation of the system 30 such that data indicative of the change in attitude based upon the attitude IMU 8 is continually updated based upon movement of the operator and the range-finding laser device 9.

Process A is the parent process that receives each set of data from the respective process C, D, and E. In this regard, process C provides data indicative of change in position and yaw, process D provides data indicative of change in position and attitude, and process E provides data indicative of change in attitude.

In step 1003, the control logic 404 fuses the data from processes C, D, and E to obtain a fused estimated change in position and attitude of the range-finding laser device 9.

In step 1004, the control logic 404 calculates a latest global pose of the range-finding laser device 9, based upon the fused data by adding the fused change in estimated position and attitude to the last global pose.

In step 1005, the control logic 404 uses the latest global pose to transform the latest scan Cartesian points from the range-finding laser device's frame of reference to the global frame of reference.

In step 1006, the control logic 404 performs a statistical outlier removal filter on the transformed scan data that lies in the global frame of reference as described hereinabove. Further, in step 1007, the control logic 404 performs a filter method that removes redundant scan data resulting from non-movement of the operator 1 during data collection. In this regard, when the operator does not move and the sensors, i.e., the range-finding laser device 9, the zupt IMUs 6 and 7, and the attitude IMU 8, continue to collect measurements and perform calculations, redundant scan data will unnecessarily accumulate. Thus, in order to ensure that such redundant data does not unnecessarily appear in the point cloud data 412, the control logic 404 removes such redundant scan data and does not add that data to the point cloud.

In step 1008, the control logic 404 adds the latest set of scan data, if not removed by Step 1007, to the point cloud data 412.

Process A begins again at step 1003. In this regard, process A is a recurring and iterative process that runs during operation of the system 30 such that point cloud data 412 is continually updated based upon movement of the range-finding laser device 9 and collection of data.

FIG. 10 depicts another embodiment of process D such as is depicted in FIG. 9. In this regard, while collecting and processing data via the mobile unit 80, the range-finding laser device 9a can vary in pitch, which means that z-measurements of scan data obtained from the range-finding laser device 9a may be used to determine information relative to three-dimensional structures within the field of view of the range-finding laser device 9a. Thus, the embodiment of Process D depicted in FIG. 10 comprises only steps 4000, 4001, 4002, and 4004.

What is claimed is:

1. A system, comprising:
a range-finding laser device coupled to an operator and configured to perform a latest scan measuring a plurality of data points indicative of range and angle relative to the location of the range-finding laser and surrounding structure which is indicative of spatial structure in the field of view of the range-finding laser device;
an attitude inertial measurement unit (IMU) that is affixed to the range-finding laser device and configured to measure pitch, roll, and yaw of the range-finding laser device;
two zero-velocity update (zupt) IMUs coupled to the operator, the zupt IMUs configured to estimate position, velocity, and yaw of the operator;
logic configured to convert each of the plurality of data points to Cartesian data points thereby generating latest scan data, compare the latest scan data with last scan data to derive data indicative of a first estimated change in position and attitude of the range-finding laser device via a scan matching method, wherein the last scan data comprises data indicative of a plurality of Cartesian data points indicative of a previous scan performed by the range-finding laser device, the logic further configured to convert the zupt IMU estimated position, velocity, and yaw to data indicative of a second estimated change in the position and attitude of the range-finding laser device, fuse the first estimated change in position and attitude and the second estimated change in position and attitude to obtain data indicative of a fused change in position and attitude of the range-finding laser device, calculate data indicative of a latest global pose based upon the data indicative of the fused change in position and attitude and data indicative of a last global pose, the logic further configured to transform the plurality of data points from a sensor frame of reference to a global frame of reference using the data indicative of the latest global pose to obtain data indicative of transformed data points and merge the data indicative of the transformed data points with a point cloud.

2. The system of claim 1, wherein the logic is further configured to eliminate data indicative of redundant range-finding laser device scans in the data indicative of the latest transformed data points resulting from slow range-finding laser device movement between scans.

3. The system of claim 1, wherein the logic is further configured to eliminate data points in the data indicative of the latest transformed data points that the logic determines to be statistical outliers.

4. The system of claim 1, wherein one of the zupt IMUs is coupled to a first foot of the operator and one of the zupt IMUs is coupled to a second foot of the operator.

5. The system of claim 4, wherein the zupt IMUs are configured to estimate position, velocity, and yaw of the operator's feet.

6. The system of claim 1, further comprising a backpack apparatus.

7. The system of claim 6, further comprising a power device coupled to the backpack apparatus.

8. The system of claim 6, further comprising a mobile computing device coupled to the backpack apparatus that executes the logic.

9. The system of claim 8, further comprising a computing device communicatively to the mobile computing device for receiving data indicative of the point cloud.

10. The system of claim 6, wherein the range-finding laser device is coupled to the backpack apparatus.

11. The system of claim 6, wherein the range-finding laser device is coupled to an extendable pole held by the operator.

12. The system of claim 6, further comprising a display device for displaying the transformed data points.

13. The system of claim 12, wherein the display device is coupled to the backpack apparatus via an arm comprising at least one pivot to enable the operator to manually position the display device in a plurality of positions.

14. The system of claim 12, wherein the display device is used to display an image indicative of the transformed data points.

15. The system of claim 1, wherein the range-finding laser device comprises a tiltable housing and a laser is contained in the tiltable housing.

16. The system of claim 15, wherein the tiltable housing is coupled to a backpack apparatus.

17. The system of claim 15, wherein the tiltable housing is coupled to an extendable pole held by the operator.

18. The system of claim 1, further comprising a camera wherein the logic is configured to captures video via the camera and correlate the captured video with the transformed data points.

19. The system of claim 1, further comprising a wrist display device configured to be worn by the operator for displaying an image indicative of the transformed data points.

20. A method, comprising:
performing a latest scan measuring a plurality of data points indicative of range and angle relative to a location of a range-finding laser and surrounding structure which is indicative of spatial structure in the field of view of the range-finding laser device;
measuring pitch, roll, and yaw of the range-finding laser device via an attitude inertial measurement unit (IMU) that is affixed to the range-finding laser device;
estimating position, velocity, and yaw of the operator via two zero-velocity update (zupt) IMUs coupled to the operator;
converting each of the plurality of data points to Cartesian data points thereby generating latest scan data;
comparing the latest scan data with last scan data to derive data indicative of a first estimated change in position and attitude of the range-finding laser device via a scan matching method, wherein the last scan data comprises data indicative of a plurality of Cartesian data points indicative of a previous scan performed by the range-finding laser device;
converting the zupt IMU estimated position, velocity, and yaw to data indicative of a second estimated change in the position and attitude of the range-finding laser device;
fusing the first estimated change in position and attitude and the second estimated change in position and attitude to obtain data indicative of a fused change in position and attitude of the range-finding laser device;
calculating data indicative of a latest global pose based upon the data indicative of the fused change in position and attitude and data indicative of a last global pose;
transforming the plurality of data points from a sensor frame of reference to a global frame of reference using the data indicative of the latest global pose to obtain data indicative of transformed data points; and
merging the data indicative of the transformed data points with a point cloud.

21. The method of claim 20, further comprising eliminating data indicative of redundant range-finding laser device scans in the data indicative of the latest transformed data points resulting from slow range-finding laser device movement between scans.

22. The method of claim 20, further comprising eliminating data points in the data indicative of the latest transformed data points determined to be statistical outliers.

23. The method of claim 20, wherein one of the zupt IMUs is coupled to a first toot of the operator and one of the zupt IMUs is coupled to a second foot of the operator.

24. The method of claim 23, further comprising estimating position, velocity, and yaw of the operator's feet via the zupt IMUs.

25. The method of claim 20, further comprising transmitting data indicative of the point cloud to a remote computing device.

26. The method of claim 20, further comprising capturing video via a camera and correlating the captured video with the transformed data points.

27. The method of claim 20, further comprising displaying data indicative of the transformed data points.
